(19) United States
(12) Patent Application Publication
(10) Pub. No.: US 2023/0327755 A1
(43) Pub. Date: Oct. 12, 2023

(54) COMMUNICATION MONITORING SYSTEM

(71) Applicant: NIPPON TELEGRAPH AND TELEPHONE CORPORATION, Tokyo (JP)

(72) Inventors: Yuka OKAMOTO, Musashino-shi, Tokyo (JP); Tomoya HATANO, Musashino-shi, Tokyo (JP); Hirotaka UJIKAWA, Musashino-shi, Tokyo (JP); Sei KOU, Musashino-shi, Tokyo (JP)

(73) Assignee: NIPPON TELEGRAPH AND TELEPHONE CORPORATION, Tokyo (JP)

(21) Appl. No.: 18/024,939

(22) PCT Filed: Sep. 11, 2020
(86) PCT No.: PCT/JP2020/034560

§ 371 Date: Mar. 6, 2023

(51) Int. Cl. H04B 10/07

(52) U.S. Cl. CPC H04B 10/07

(57) ABSTRACT

Provided is a communication monitoring system capable of monitoring a state of a connection device that forms an optical path by using an optical passive component. A communication monitoring system (1) includes a plurality of photodetectors (9) provided in a connection device (6), a plurality of recognition units (13), a processing unit (14), a light emitting unit (15), a mixing unit (12), a separation unit (16), a collection unit (17), and a management unit (18). The photodetector (9) detects an optical signal passing through a corresponding optical path. The recognition unit (13) recognizes a state of detection by the corresponding photodetector (9). The processing unit (14) generates information regarding a communication state of the connection device (6) on the basis of the recognition by each recognition unit (13). The light emitting unit (15) converts the generated information into a monitoring signal that is an optical signal and transmits the monitoring signal. The monitoring signal is passed through an optical communication line (3) as a mixed signal by the mixing unit (12) and is separated from the mixed signal by the separation unit (16). The collection unit (18) outputs the separated monitoring signal to the management unit (18) that manages a state of a PON (2).

### TECHNICAL FIELD

The present disclosure relates to a communication monitoring system.

### BACKGROUND ART

Patent Literature 1 and Non Patent Literature 1 disclose examples of a communication system. In the communication system, a passive optical network (PON) including a plurality of optical network units (ONUs) and an optical line terminal (OLT) is built. The communication system includes an optical splitter that connects the plurality of ONUs and the OLT. In the communication system of Patent Literature 1, a malfunction of an ONU #1 among the plurality of ONUs is estimated by a warning message issued from the ONU #1. In the communication system, in a case where a message indicating “normal” is obtained from ONUs other than the ONU #1, a malfunction of an optical communication line between the ONU #1 and the optical splitter is estimated.

### CITATION LIST

### Patent Literature

Patent Literature 1: JP 2010-171652 A

### Non Patent Literature

Non Patent Literature 1: GE-PON technology, NTT Technical Review, pp. 91 to 94, September 2005

### SUMMARY OF INVENTION

### Technical Problem

However, the communication system of Patent Literature 1 monitors a malfunction on the basis of messages communicated between the plurality of ONUs and the OLT. Therefore, a state of a connection device such as the optical splitter that connects optical communication lines by using an optical passive component to form optical paths through which optical signals pass is not monitored.

The present disclosure solves such a problem. The present disclosure provides a communication monitoring system capable of monitoring a state of a connection device that forms an optical path by using an optical passive component.

### Solution to Problem

A communication monitoring system according to the present disclosure includes: a plurality of photodetectors provided in a connection device that connects a plurality of optical communication lines by using an optical passive component to form a plurality of optical paths through which optical signals pass, each of the plurality of photodetectors corresponding to any one of the plurality of optical paths and being configured to detect an optical signal passing through the corresponding optical path; a plurality of recognition units, each of the plurality of recognition units corresponding to any one of the plurality of photodetectors and being configured to recognize a state of detection of the optical signal by the corresponding photodetector; a processing unit configured to generate information regarding a communication state of the connection device on the basis of information regarding the state of detection recognized by each of the plurality of recognition units; a light emitting unit configured to convert the information regarding the communication state of the connection device generated by the processing unit into an optical signal and transmits the optical signal as a monitoring signal; a mixing unit corresponding to any one of the plurality of optical communication lines and configured to pass, through the corresponding optical communication line, a mixed signal obtained by mixing the monitoring signal transmitted by the light emitting unit and the optical signal passing through the optical communication line; a separation unit configured to separate the monitoring signal from the mixed signal passing through the optical communication line corresponding to the mixing unit; a collection unit configured to receive the monitoring signal separated by the separation unit and output the information regarding the communication state indicated by the monitoring signal; and a management unit configured to manage a state of a network including the connection device on the basis of the information output by the collection unit.

### Advantageous Effects of Invention

A communication monitoring system according to the present disclosure can monitor a state of a connection device that forms an optical path by using an optical passive component.

### BRIEF DESCRIPTION OF DRAWINGS

FIG. 1 is a configuration diagram of a communication monitoring system according to a first embodiment.

FIG. 2 is a block diagram of the communication monitoring system according to the first embodiment.

FIG. 3 is a block diagram of a communication monitoring system according to a second embodiment.

### DESCRIPTION OF EMBODIMENTS

Embodiments of the present disclosure will be described with reference to the accompanying drawings. In each drawing, the same or corresponding parts are denoted by the same reference signs, and redundant description will be appropriately simplified or omitted. Note that the present disclosure is not limited to the following embodiments, and it is possible to freely combine the embodiments, modify any component of the embodiments, or omit any component of the embodiments, without departing from the gist of the present disclosure.

### First Embodiment

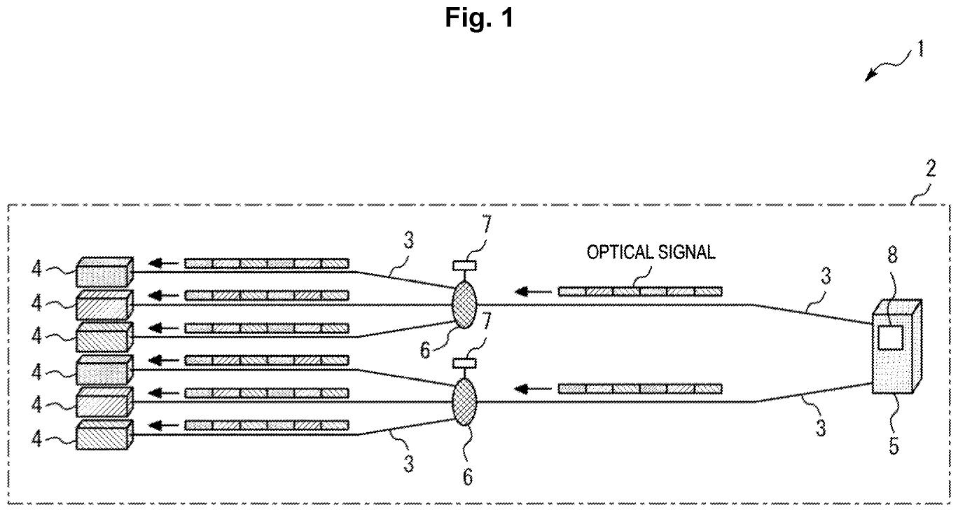

FIG. 1 is a configuration diagram of a communication monitoring system 1 according to a first embodiment.

The communication monitoring system 1 monitors a state of a network in which information is communicated. In this example, the communication monitoring system 1 monitors a state of a PON 2. In the PON 2, information is communicated by optical signals passing through optical communication lines 3. The optical communication lines 3 are, for example, optical fiber cables. The PON 2 includes a plurality of ONUS 4, an OLT 5, and a plurality of connection devices 6.

Each ONU 4 is disposed in a base, house, or the like of a member that receives provision of a communication service in the communication system. For example, each ONU 4 converts an electrical signal from a terminal device or the like that the member uses into an optical signal and transfers the optical signal to the OLT 5. The terminal device that the member uses is, for example, a personal computer.

The OLT 5 is disposed in a base or the like of a service provider that provides the communication service in the communication system. For example, the OLT 5 transfers a signal between the ONUS 4 and an upper network or the like. The upper network is, for example, the Internet.

Each connection device 6 connects the plurality of optical communication lines 3 to form a plurality of optical paths through which optical signals pass. Each optical path is, for example, a path connecting a unit to a unit of the communication system, such as the ONUs 4, the OLT 5, and the connection devices 6. For example, each connection device 6 relays, splits, or combines optical signals passing through the plurality of optical communication lines 3. The connection device 6 may switch the optical paths through which optical signals pass depending on a frequency, for example. In this example, each connection device 6 connects the plurality of optical communication lines 3 connected to some of the plurality of ONUs 4 and the optical communication line 3 connected to the OLT 5 in a one-to-many relationship. The connection device 6 may connect the plurality of optical communication lines 3 connected to the units of the communication system, such as the ONUs 4, the OLT 5, and the connection devices 6, in a many-to-many relationship.

The communication monitoring system 1 includes a plurality of communication monitoring devices 7 and a management device 8.

Each communication monitoring device 7 corresponds to any one of the connection devices 6. Each communication monitoring device 7 is provided in the corresponding connection device 6. Each communication monitoring device 7 monitors a communication state of the corresponding connection device 6. Each communication monitoring device 7 has a function of transmitting the monitored communication state of the connection device 6. The communication monitoring device 7 is, for example, outside the connection device 6 and detachably attached to the connection device 6.

The management device 8 manages information regarding a state of the PON 2. The management device 8 is outside the communication monitoring device 7. The management device 8 is incorporated in a housing device that houses the OLT 5, for example. Alternatively, the management device 8 may be provided outside the housing device that houses the OLT 5.

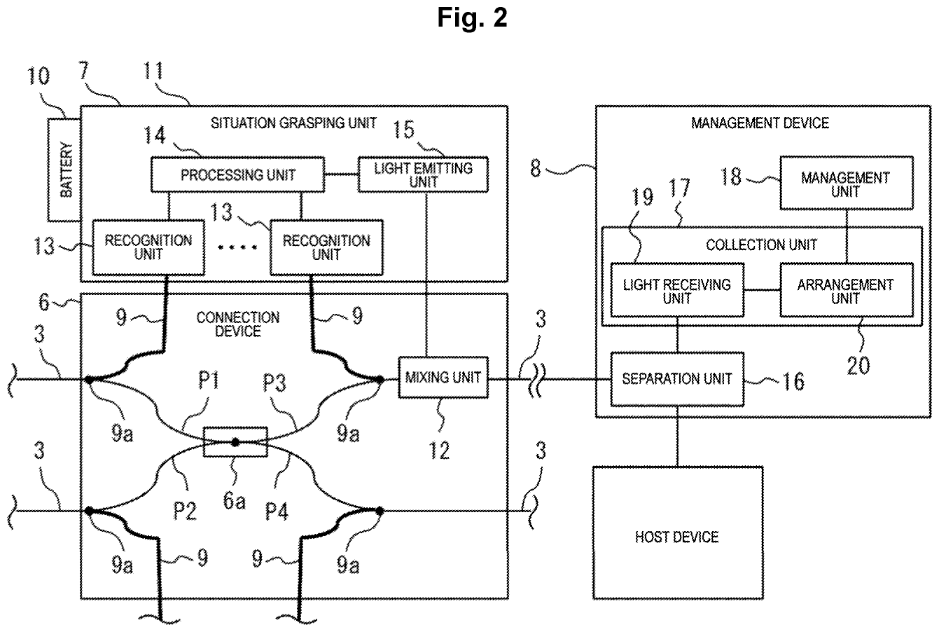

FIG. 2 is a block diagram of the communication monitoring system 1 according to the first embodiment.

In the PON 2 monitored by the communication monitoring system 1, each connection device 6 includes an optical passive component. The connection device 6 connects the plurality of optical communication lines 3 by using the optical passive component. The optical passive component is, for example, an optical coupler, optical splitter, optical patch panel, or optical switch. The optical passive component includes no electrical element. The optical passive component functions without requiring supply of power or the like. That is, the connection device 6 forms an optical path without using an electrical element. Therefore, the connection device 6 hardly fails.

In this example, the connection device 6 forms four optical paths, i.e., an optical path P1, an optical path P2, an optical path P3, and an optical path P4 by using an optical coupler 6a serving as an example of the optical passive component. The connection device 6 splits an optical signal entering from the optical path P1 into the optical path P3 and the optical path P4. The connection device 6 splits an optical signal entering from the optical path P2 into the optical path P3 and the optical path P4. The connection device 6 splits an optical signal entering from the optical path P3 into the optical path P1 and the optical path P2. The connection device 6 splits an optical signal entering from the optical path P4 into the optical path P1 and the optical path P2.

Each communication monitoring device 7 of the communication monitoring system 1 includes a plurality of photodetectors 9, a battery 10, a situation grasping unit 11, and a mixing unit 12. In this example, the communication monitoring device 7 includes the same number of photodetectors 9 as the plurality of optical paths formed by the connection device 6.

The plurality of photodetectors 9 is provided in the connection device 6. Each photodetector 9 corresponds to any one of the plurality of optical paths. The photodetector 9 detects an optical signal passing through the corresponding optical path. The photodetector 9 includes an optical splitter 9a. The optical splitter 9a splits an optical signal passing through the optical path into a main signal and a sub-signal. The optical splitter 9a may split the optical signal into the main signal and the sub-signal as signals having different intensities. At this time, the intensity of the sub-signal is smaller than the intensity of the main signal. Further, the optical splitter 9a may selectively split an optical signal depending on a direction. At this time, among optical signals passing through the corresponding optical path, the optical splitter 9a splits an optical signal entering the connection device 6 into a main signal and a sub-signal. Meanwhile, among the optical signals passing through the corresponding optical path, the optical splitter 9a does not split an optical signal emitted from the connection device 6. The photodetector 9 extracts the sub-signal split by the optical splitter 9a as described above from the corresponding optical path.

The battery 10 supplies power to the situation grasping unit 11. The battery 10 may be, for example, a storage battery that accumulates supplied power. The situation grasping unit 11 may be connected to an external power supply. In this case, the situation grasping unit 11 may normally receive supply of power from the external power supply. Further, the power supplied from the external power supply is normally accumulated in the battery 10. Meanwhile, when a power failure occurs, the situation grasping unit 11 may switch a supply source of power from the external power supply to the battery 10.

The situation grasping unit 11 includes a plurality of recognition units 13, a processing unit 14, and a light emitting unit 15. In this example, the situation grasping unit 11 includes the same number of recognition units 13 as the plurality of photodetectors 9 included in the communication monitoring device 7.

Each recognition unit 13 corresponds to any one of the plurality of photodetectors 9. Each recognition unit 13 recognizes a state of detection of an optical signal by the corresponding photodetector 9. Each recognition unit 13 receives input of the sub-signal split from the optical path by the corresponding photodetector 9. Each recognition unit 13 recognizes the state of detection of the optical signal by the corresponding photodetector 9 on the basis of the input sub-signal. Each recognition unit 13 may include a light receiving element such as a photodiode that converts the input optical signal into an electrical signal. The state of detection of the optical signal includes, for example, presence/absence of the optical signal passing through the optical path. The state of detection of the optical signal may include an intensity of the optical signal passing through the optical path. Each recognition unit 13 outputs information regarding the recognized state of detection to the processing unit 14.

The processing unit 14 performs information processing of the information output from each recognition unit 13. The processing unit 14 generates information regarding a communication state of the connection device 6 on the basis of the information regarding the state of detection output from each recognition unit 13. The information regarding the communication state of the connection device 6 includes, for example, information regarding presence/absence of an optical signal passing through each optical path. The processing unit 14 performs processing for gathering the states of detection output from the respective recognition units 13 as the information regarding the communication state of the connection device 6. The processing unit 14 performs processing for converting the information regarding the communication state of the connection device 6 into a format processable in the management device 8. In this example, the processing unit 14 constantly generates the information regarding the communication state of the connection device 6. Alternatively, the processing unit 14 may generate the information regarding the communication state of the connection device 6 once every preset period of time.

The light emitting unit 15 converts the information regarding the communication state of the connection device 6 generated in the processing unit 14 into an optical signal and transmits the optical signal as a monitoring signal. In this example, the light emitting unit 15 transmits the monitoring signal as an optical signal having a frequency band different from that of the main signal passing through the optical path. For example, the light emitting unit 15 may newly provide a channel having a wavelength different from that of the main signal and transmit the monitoring signal as an optical signal of the channel. Alternatively, the light emitting unit 15 may transmit the monitoring signal as an optical signal of a channel such as an auxiliary management and control channel (AMCC). In a case where the processing unit 14 constantly generates the information regarding the communication state, the light emitting unit 15 constantly transmits the monitoring signal. Alternatively, in a case where the processing unit 14 generates the information regarding the communication state every preset period of time, the light emitting unit 15 transmits the monitoring signal every preset period of time.

The mixing unit 12 corresponds to any one of the optical communication lines 3 connected by the connection device 6. In the connection device 6, the mixing unit 12 is provided in an optical path including the corresponding optical communication line 3. In this example, the mixing unit 12 is provided in the optical path P3. The mixing unit 12 mixes a main signal passing through the optical path and the monitoring signal transmitted by the light emitting unit 15. The mixing unit 12 mixes the main signal and the monitoring signal and outputs a mixed signal. The mixed signal output from the mixing unit 12 is input to the management device 8 through the optical communication line 3 corresponding to the mixing unit 12. The mixing unit 12 may mix the main signal and the monitoring signal by using, for example, an optical passive component. A plurality of mixing units 12 may be provided in the connection device 6.

The management device 8 includes a separation unit 16, a collection unit 17, and a management unit 18.

The separation unit 16 separates the monitoring signal and the main signal from the mixed signal passing through the optical communication line 3 corresponding to the mixing unit 12. The separation unit 16 may separate the main signal and the monitoring signal from the mixed signal by using, for example, an optical passive component. The separation unit 16 outputs the separated main signal to a host device or the like of the PON 2. The separation unit 16 may output the separated main signal to the OLT 5. The separation unit 16 outputs the separated monitoring signal to the collection unit 17.

The collection unit 17 includes a light receiving unit 19 and an arrangement unit 20. The light receiving unit 19 receives the monitoring signal output by the separation unit 16. The light receiving unit 19 converts the monitoring signal that is an optical signal into an electrical signal. The light receiving unit 19 outputs the electrical signal converted from the monitoring signal to the arrangement unit 20. The arrangement unit 20 arranges the electrical signal output by the light receiving unit 19 as the information regarding the communication state of the connection device 6. The arrangement unit 20 performs, for example, processing for arranging the information regarding the communication state of the connection device 6 as a format processable in the management unit 18. The arrangement unit 20 outputs the arranged information regarding the communication state of the connection device 6 to the management unit 18.

The management unit 18 manages the information output from the collection unit 17. In this example, the management unit 18 manages the information output from the collection unit 17, for example, accumulates or analyzes the information. The information managed in the management unit 18 is used to, for example, handle a failure in the PON 2.

Next, an example of an operation of the communication monitoring device 7 will be described with reference to FIG. 2.

When an optical signal enters the connection device 6 through the optical path P1, the optical splitter 9a of the photodetector 9 corresponding to the optical path P1 splits the optical signal passing through the optical path P1 into a main signal and a sub-signal. The photodetector 9 inputs the sub-signal to the recognition unit 13 corresponding to the photodetector 9. The recognition unit 13 recognizes a state of detection of the optical signal passing through the optical path P1 on the basis of the input sub-signal. The recognition unit 13 outputs the recognized state of detection to the processing unit 14. The optical coupler 6a of the connection device 6 splits the main signal passing through the optical path P1 into the optical path P3 and the optical path P4. In this example, the optical coupler 6a splits the main signal at a split ratio of 1:1. Optical signals split by the optical coupler 6a are emitted from the connection device 6 through the optical path P3 and the optical path P4. At this time, the optical splitter 9a of the photodetector 9 corresponding to the optical path P3 does not split the optical signal passing through the optical path P3. The optical splitter 9a of the photodetector 9 corresponding to the optical path P4 does not split the optical signal passing through the optical path P4.

In this case, the processing unit 14 acquires information indicating that the optical signal passing through the optical path P1 has been detected as information regarding the state of detection. Based on the acquired information, the processing unit 14 generates information regarding a communication state of the connection device 6, the information indicating that the optical signal has been detected in the optical path P1 of the connection device 6.

The light emitting unit 15 transmits the information regarding the communication state generated by the processing unit 14 to the mixing unit 12 as a monitoring signal. The mixing unit 12 mixes a main signal passing through the optical path P3 and the monitoring signal transmitted by the light emitting unit 15 and outputs a mixed signal.

The mixed signal is received by the management device 8 through the optical communication line 3. The mixed signal is separated into the monitoring signal and the main signal in the separation unit 16 of the management signal. The separated main signal is output to the host device or the like. The separated monitoring signal is output to the light receiving unit 19. The light receiving unit 19 converts the monitoring signal into an electrical signal. The arrangement unit 20 arranges the electrical signal converted by the light receiving unit 19 as the information regarding the communication state of the connection device 6. The arrangement unit 20 outputs the arranged information regarding the communication state of the connection device 6 to the management unit 18.

The management unit 18 accumulates the information regarding the communication state of the connection device 6 arranged by the arrangement unit 20. The management unit 18 may analyze a state of the PON 2 on the basis of the accumulated information regarding the communication state. The information accumulated in the management unit 18 may be used to, for example, handle a failure by an operator who performs a maintenance operation of the PON 2.

Next, there will be described an example of a hardware configuration of units or devices of the communication monitoring system 1 including the situation grasping unit 11, the management device 8, and the like. The units or devices of the communication monitoring system 1 include a processing circuit including, for example, a processor and memory as hardware. The processor is, for example, a central processing unit (CPU), arithmetic device, microprocessor, or microcomputer. The memory corresponds to, for example: a nonvolatile or volatile semiconductor memory such as a random-access memory (RAM), read-only memory (ROM), flash memory, erasable programmable read-only memory (EPROM), or electrically erasable programmable read-only memory (EEPROM); magnetic disk; flexible disk; optical disk; compact disk; mini disk; or digital versatile disc (DVD). The memory stores, for example, a program as software or firmware. Further, the units or devices of the communication monitoring system 1 perform preset processing by the processor executing the program or the like stored in the memory, thereby implementing each function as a result of cooperation of hardware and software. The function of each of the units or devices of the communication monitoring system 1 may be implemented by the processing circuit. Alternatively, some or all of the functions of the units or devices of the communication monitoring system 1 may be collectively implemented by the processing circuit. The processing circuit may be implemented by, for example, a single circuit, composite circuit, programmed processor, parallel programmed processor, application-specific integrated circuit (ASIC), field-programmable gate array (FPGA), or combination thereof.

As described above, the communication monitoring system 1 according to the first embodiment includes the plurality of photodetectors 9, the plurality of recognition units 13, the processing unit 14, the light emitting unit 15, the mixing unit 12, the separation unit 16, the collection unit 17, and the management unit 18. The plurality of photodetectors 9 is provided in the connection device 6. The connection device 6 connects the plurality of optical communication lines 3 by using an optical passive component to form a plurality of optical paths through which optical signals pass. Each photodetector 9 corresponds to any one of the optical paths. Each photodetector 9 detects an optical signal passing through the corresponding optical path. Each recognition unit 13 corresponds to any one of the photodetectors 9. Each recognition unit 13 recognizes a state of detection of the optical signal by the corresponding photodetector 9. The processing unit 14 generates information regarding a communication state of the connection device 6 on the basis of information regarding the state of detection recognized by each recognition unit 13. The light emitting unit 15 converts the information regarding the communication state of the connection device 6 generated by the processing unit 14 into an optical signal and transmits the optical signal as a monitoring signal. The mixing unit 12 corresponds to any one of the optical communication lines 3. The mixing unit 12 passes, through the corresponding optical communication line 3, a mixed signal obtained by mixing the monitoring signal transmitted by the light emitting unit 15 and the optical signal passing through the optical communication line 3. The separation unit 16 separates the monitoring signal from the mixed signal passing through the optical communication line 3 corresponding to the mixing unit 12. The collection unit 17 receives the monitoring signal separated by the separation unit 16. The collection unit 17 outputs the information regarding the communication state indicated by the monitoring signal. The management unit 18 manages a state of a network such as the PON 2 including the connection device 6 on the basis of the information output by the collection unit 17.

With such a configuration, when the communication monitoring device 7 is applied to the connection device 6 that forms an optical path by using an optical passive component, it is possible to monitor a state of the connection device 6 including no electrical element. Therefore, even in a case where a wiring error, disconnection of the optical communication line 3 connected by the connection device 6, or the like occurs, it is possible to confirm the state of the network by using the management device 8 or the like, without checking the actual error or disconnection. This increases an operation rate of the network. In particular, the state of the network can be more efficiently managed in a case where a large number of connection devices 6 are scattered in various positions. In a case where the communication monitoring device 7 is attached as an external device, a main signal in the connection device 6 is hardly affected even in a case where the communication monitoring device 7 fails. In a case where the battery 10 is provided in the communication monitoring device 7, monitoring continues even in a case where supply of power from the external power supply is stopped when a power failure occurs, for example. Because the connection device 6 itself does not require power supply, a main signal in the connection device 6 is hardly affected even when a power failure occurs, for example. Note that, for example, in a case where the connection device 6 is not monitored when a power failure occurs, the communication monitoring device 7 may not include the battery 10.

The processing unit 14 generates information including presence/absence of the optical signal passing through each optical path as the information regarding the communication state of the connection device 6. Therefore, a communication state of the individual optical path in the connection device 6 is grasped, and thus it is possible to more efficiently manage the state of the network by using more detailed information.

Each photodetector 9 splits the optical signal passing through the corresponding optical path. Each recognition unit 13 recognizes the state of detection of the optical signal by the corresponding photodetector 9 on the basis of the optical signal split by the photodetector 9. Therefore, the photodetector 9 is formed without using an electrical element.

Each photodetector 9 splits the optical signal passing through the optical path into a main signal and a sub-signal. The intensity of the sub-signal is smaller than the intensity of the main signal. Each recognition unit 13 recognizes the state of detection of the optical signal by the corresponding photodetector 9 on the basis of the sub-signal split by the photodetector 9. Therefore, a decrease in the intensity of the main signal caused by monitoring can be reduced.

Each photodetector 9 splits an optical signal entering the connection device 6 among optical signals passing through the corresponding optical path. Each recognition unit 13 recognizes a state of detection of the optical signal by the corresponding photodetector 9 on the basis of the optical signal entering the connection device 6 and split by the photodetector 9. Therefore, even in a case where the connection device 6 splits an optical signal, the optical signal is detected on an upstream side of the split, and thus it is clear in which optical path the optical signal is detected. This generates information regarding the communication state of the connection device 6 with which the state of the network is more easily grasped.

The light emitting unit 15 may transmit the information regarding the communication state of the connection device 6 as a monitoring signal every preset period of time. Therefore, there is no need to generate the information regarding the communication state that is not transmitted, and thus power consumption in the communication monitoring device 7 is saved.

The light emitting unit 15 may transmit the monitoring signal as an optical signal having a frequency band different from that of the main signal that passes through the optical communication line 3 corresponding to the mixing unit 12 and has not yet been mixed. Therefore, deterioration of the main signal caused by interference with the monitoring signal can be reduced.

### Second Embodiment

In a second embodiment, points different from the example disclosed in the first embodiment will be described in particular detail. Any feature of the example disclosed in the first embodiment may be adopted as a feature not described in the second embodiment.

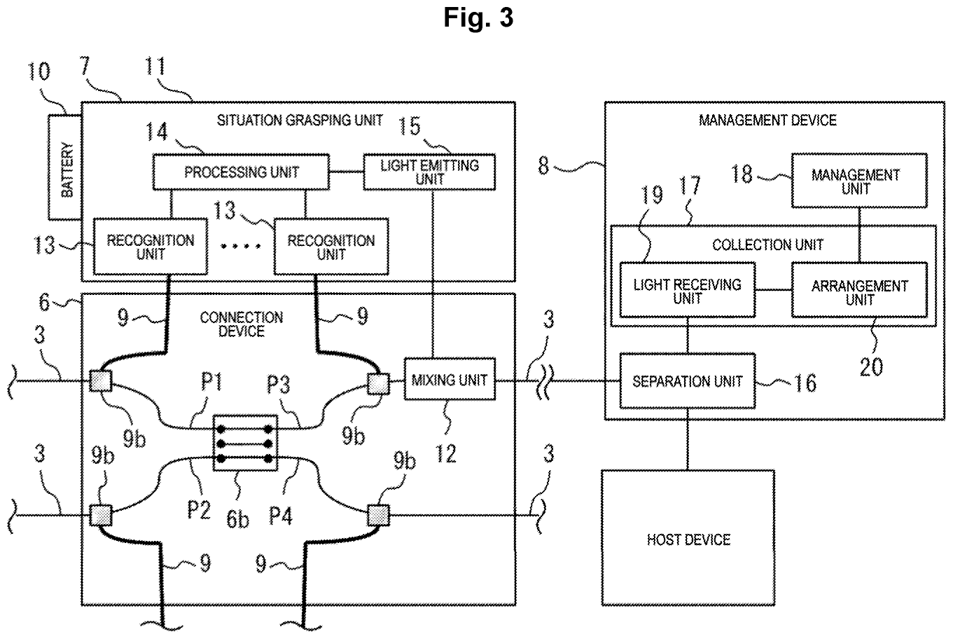

FIG. 3 is a block diagram of the communication monitoring system 1 according to the second embodiment.

In this example, the connection device 6 forms four optical paths, i.e., the optical path P1, the optical path P2, the optical path P3, and the optical path P4 by using an optical patch panel 6b serving as an example of the optical passive component. The connection device 6 relays an optical signal entering from the optical path P1 to the optical path P3. The connection device 6 relays an optical signal entering from the optical path P2 to the optical path P4. The connection device 6 relays an optical signal entering from the optical path P3 to the optical path P1. The connection device 6 relays an optical signal entering from the optical path P4 to the optical path P2.

Each photodetector 9 of the communication monitoring device 7 includes a light receiving element 9b provided in the corresponding optical path. The light receiving element 9b is, for example, an element such as a photodiode that converts an optical signal passing through the optical path in which the light receiving element is provided and outputs a detection signal. The detection signal is, for example, a signal whose format is recognizable by the recognition unit 13, such as an electrical signal. The light receiving element 9b detects, for example, light leaking from the optical path. Each recognition unit 13 recognizes a state of detection of the optical signal by the corresponding photodetector 9 on the basis of the detection signal output by the photodetector 9. Each recognition unit 13 outputs information regarding the recognized state of detection to the processing unit 14. The processing unit 14 generates information regarding a communication state of the connection device 6 on the basis of the information regarding the state of detection output from each recognition unit 13. The light emitting unit 15 transmits the information regarding the communication state of the connection device 6 generated in the processing unit 14 to the mixing unit 12 as a monitoring signal. The mixing unit 12 mixes a main signal passing through the optical path and the monitoring signal transmitted by the light emitting unit 15 and outputs a mixed signal. The mixed signal is received by the management device 8 through the optical communication line 3. In the management device 8, the information regarding the communication state of the connection device 6 is input to the management unit 18 on the basis of the monitoring signal separated from the mixed signal. Note that each photodetector 9 may convert a sub-signal split from the corresponding optical path by an optical splitter or the like into a detection signal by using the light receiving element.

As described above, each photodetector 9 of the communication monitoring device 7 according to the second embodiment converts an optical signal passing through the corresponding optical path and outputs a detection signal. Each recognition unit 13 recognizes a state of detection of the optical signal by the corresponding photodetector 9 on the basis of the detection signal output from the photodetector 9. Therefore, the recognition unit 13 receives the detection signal whose format is directly recognizable, such as an electrical signal, and thus recognition processing in the recognition unit 13 becomes easy.

### INDUSTRIAL APPLICABILITY

A communication monitoring system according to the present disclosure is applicable to monitoring a state of a network in which information is communicated by an optical signal.

### REFERENCE SIGNS LIST

1 Communication monitoring system
2 PON
3 Optical communication line
4 ONU
5 OLT
6 Connection device
6a Optical coupler
6b Optical patch panel
7 Communication monitoring device
8 Management device
9 Photodetector
9a Optical splitter
9b Light receiving element
10 Battery
11 Situation grasping unit
12 Mixing unit
13 Recognition unit
14 Processing unit
15 Light emitting unit
16 Separation unit
17 Collection unit
18 Management unit
19 Light receiving unit
20 Arrangement unit

1. A communication monitoring system comprising:
a plurality of photodetectors provided in a connection device that connects a plurality of optical communication lines by using an optical passive component to form a plurality of optical paths through which optical signals pass, each of the plurality of photodetectors corresponding to any one of the plurality of optical paths and being configured to detect an optical signal passing through the corresponding optical path;
a plurality of recognition units, each of the plurality of recognition units corresponding to any one of the plurality of photodetectors and being configured to recognize a state of detection of the optical signal by the corresponding photodetector;
a processing unit configured to generate information regarding a communication state of the connection device on the basis of information regarding the state of detection recognized by each of the plurality of recognition units;
a light emitting unit configured to convert the information regarding the communication state of the connection device generated by the processing unit into an optical signal and transmit the optical signal as a monitoring signal;
a mixing unit corresponding to any one of the plurality of optical communication lines and configured to pass, through the corresponding optical communication line, a mixed signal obtained by mixing the monitoring signal transmitted by the light emitting unit and the optical signal passing through the optical communication line;
a separation unit configured to separate the monitoring signal from the mixed signal passing through the optical communication line corresponding to the mixing unit;
a collection unit configured to receive the monitoring signal separated by the separation unit and output the information regarding the communication state indicated by the monitoring signal; and
a management unit configured to manage a state of a network including the connection device on the basis of the information output by the collection unit.

2. The communication monitoring system according to claim 1, wherein
the processing unit generates information including presence/absence of the optical signal passing through each of the plurality of optical paths as the information regarding the communication state of the connection device.

3. The communication monitoring system according to claim 1, wherein:
each of the plurality of photodetectors splits the optical signal passing through the corresponding optical path; and
each of the plurality of recognition units recognizes the state of detection of the optical signal by the corresponding photodetector on the basis of the optical signal split by the photodetector.

4. The communication monitoring system according to claim 3, wherein:
each of the plurality of photodetectors splits the optical signal passing through the corresponding optical path into a main signal and a sub-signal having a smaller intensity than an intensity of the main signal; and
each of the plurality of recognition units recognizes the state of detection of the optical signal by the corresponding photodetector on the basis of the sub-signal split by the photodetector.

5. The communication monitoring system according to claim 3, wherein:
each of the plurality of photodetectors splits an optical signal entering the connection device among optical signals passing through the corresponding optical path; and
each of the plurality of recognition units recognizes a state of detection of the optical signal by the corresponding photodetector on the basis of the optical signal entering the connection device and split by the photodetector.

6. The communication monitoring system according to claim 1, wherein:
each of the plurality of photodetectors converts the optical signal passing through the corresponding optical path and outputs a detection signal; and
each of the plurality of recognition units recognizes the state of detection of the optical signal by the corresponding photodetector on the basis of the detection signal output from the photodetector.

7. The communication monitoring system according to claim 1, wherein
the light emitting unit transmits the information regarding the communication state of the connection device as the monitoring signal every preset period of time.

8. The communication monitoring system according to claim 1, wherein
the light emitting unit transmits the monitoring signal as an optical signal having a frequency band different from a frequency band of the optical signal that passes through the optical communication line corresponding to the mixing unit and has not yet been mixed.
